(19) United States
(12) Patent Application Publication
(10) Pub. No.: US 2002/0054105 A1
(43) Pub. Date: May 9, 2002

(54) Method, system and graphic user interface for a compound view onto data of a database

(75) Inventors: Matthias Breuer, Seevetal (DE); Frank Schönheit, Hamburg (DE)

Correspondence Address: Forrest Gunnison, Gunnison, McKay & Hodgson, L.L.P., 1900 Garden Road, Suite 220, Monterey, CA, 93940, US

(73) Assignee: Sun Microsystems, Inc.

(21) Appl. No.: 09/726,851

(22) Filed: Nov. 30, 2000

(30) Foreign Application Priority Data
Dec. 14, 1999 (EP) 99124938.4

(51) Int. Cl. G09G 5/00

(52) U.S. Cl. 345/764

(57) ABSTRACT

The invention relates to a method of accessing data of a database by displaying a form view onto data of said database, and simultaneously displaying a table view onto data accessed by said form view.

### BACKGROUND OF THE INVENTION

1. Field of the Invention

The present invention relates to the view a user has onto a database, and in particular, the invention relates to a graphic user interface for viewing data in a database.

2. Description of Related Art

Databases are commonly used on computers. Databases store data, which are of interest to a user, and the databases provide the user with sophisticated tools to query, modify, and display the stored data.

One type of commonly used databases is the so-called relational database, where data are stored in tables, which are arranged in columns and rows. One row of such a table commonly is referred to as dataset. A dataset forms a piece of data of its own and is organized in individual data fields, which somehow inherently belong together in the sense that each of the data fields, or better the content of each of the data fields, describes one certain aspect of the dataset.

FIG. 1 schematically shows the configuration of a database 150 with a database management system 100 and several tables 110, 120, and 130 in which data are stored arranged in columns and rows. DBMS 100 is used to retrieve, query, or edit the data stored in tables 110, 120, and 130, and to output the result of, for example, a query to the user.

If for example, database 150 were used to collect data on films or movies, one dataset typically would describe a specific movie. The individual data fields of a dataset would describe different attributes of the movie, like the director, the genre (comedy, action, etc.), the title, the production year, and so on. The database typically consists of several such datasets, sometimes called records, which respectively contain information about individual films.

It is known to access the data stored in such a database in two different manners, one being a table view onto the table data, the other one being a so-called form view. In a table view onto the data, the user may enter a certain query by defining certain search conditions, e.g., select all films of a particular time period, and as an output to the query, a table is produced listing all the datasets, which contain data about movies produced in the specified time period.

A result of a query is shown in FIG. 2A in a table view. Rows 220, 230, 240 form individual datasets. The columns of table 200 consist of the data fields of the individual datasets and are identified by the headings in row 210.

A different view onto data of a database is the so-called form view. A form in window 250 (FIG. 2B) contains several fields where data can be inserted. Each field corresponds to a column of the database table and is labeled by a corresponding title. For example, one field 251 refers to the title of a film and is labeled “Title”. Another field 252 refers to the director of the film and is labeled “Director”. Still another field 253 refers to the genre of the film and finally yet another field 254 refers to the length in minutes of the film, and so on.

Thus, when using the form view onto the data of a database, there is displayed a form where the fields of the form are filled by the corresponding contents of the data fields of a dataset of the database table accessed by the form view. Unlike the table view, a form view displays only a single record or dataset of a database table.

However, usually arrow buttons 256 are provided to enable the user to travel through the datasets accessed by the form view. The form shown in FIG. 2B displays the second dataset 230 shown in FIG. 2A. At the left-hand bottom of window 250, there is a field 257 indicating that data record No. 2 of 40 total records is displayed.

The form view also may be used as a filter mask to carry out a search on the contents of a database table. In such a case, a search button 255 is provided so that the user can carry out a search based on the conditions, which have been entered into fields 251 to 254. For that purpose, these data fields in the form may also be provided with pull-down menus so that the user can select possible entries.

The form view onto the data of a database certainly has its advantages when compared with the table view because the form view is very easy to use and easy to review. Nevertheless, the form view has the drawback that only a single dataset or data record can be viewed at a time.

### SUMMARY OF THE INVENTION

According to an aspect of the present invention, a graphic user interface simultaneously provides a user with a table view and a form view onto the data of a database. This compound view allows the user to take advantage of the form view being very easy to use, while at the same time several records are displayed to the user in a table view enabling the user to look at several datasets at the same time.

By providing the user with a synchronous display of a table view and a form view onto a dataset in the data source of a database, the user can, for example, in the table view quickly amend any dataset surrounding the dataset displayed in the form view, without needing to jump through form views one record, i.e., dataset, at a time. Since both views are synchronous, any amendment in one of the views is readily displayed in the other view. Preferably, the user, in both views, is provided with options for editing and/or going through the datasets to make use of the advantages of a form view and a table view onto database data at the same time.

In one embodiment, only one table view onto one (logical) data source is displayed if the form view utilizes more than one (logical) form, which means the form view uses more than one data source. In this case, the user can, by setting the cursor to the other logical form, adapt the table view also to this data source.

### BRIEF DESCRIPTION OF THE DRAWINGS

FIG. 1 is a block diagram of the configuration of a prior art database.

FIG. 2A is a diagram of a table in the prior art database of FIG. 1.

FIG. 2B is a form used with the prior art database of FIG. 1.

FIG. 3 is a block diagram of a computer system, which can be used in connection with the method and graphic user interface of the present invention.

FIG. 4 is a window that includes a form with a compound view button in accordance with an embodiment of the invention.

FIG. 5 is an illustration of a compound window view in accordance with an embodiment of the invention.

FIG. 6A is an illustration of an embodiment of the compound window view of this invention where the form view window includes more than one logical form so that the compound view window is associated with more than one data source.

FIG. 6B is an illustration of an embodiment of the compound window view of this invention where the form view window includes more than one logical form and a plurality of data sources associated with logical forms in the form view window are included in multiple table view windows within the compound window view.

FIG. 7 is yet another embodiment of the compound view window onto a database in accordance with an embodiment of the invention.

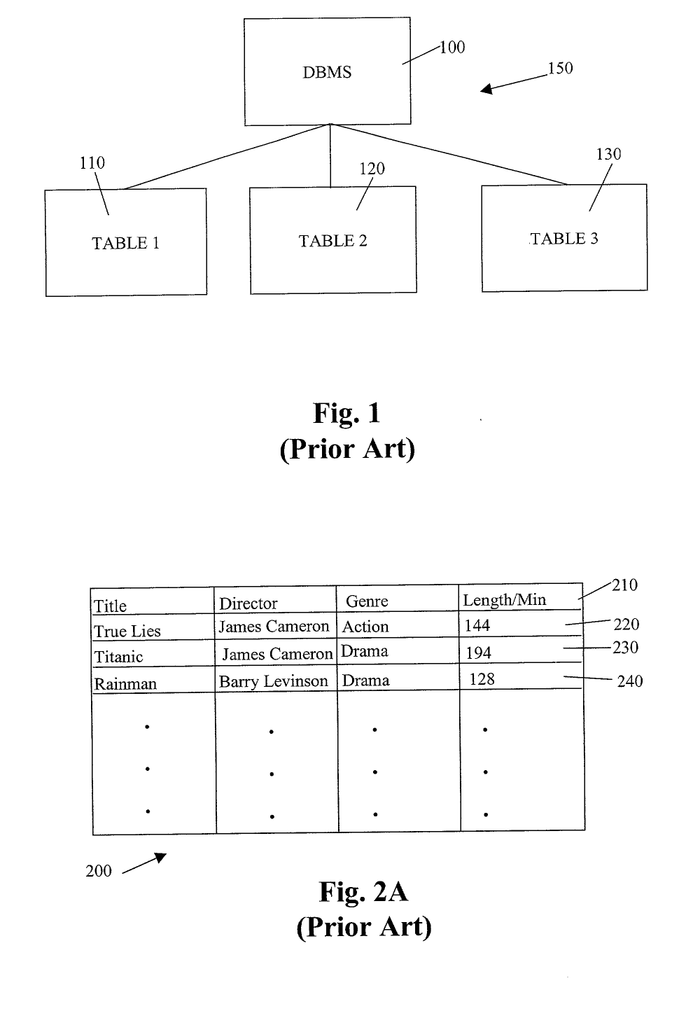

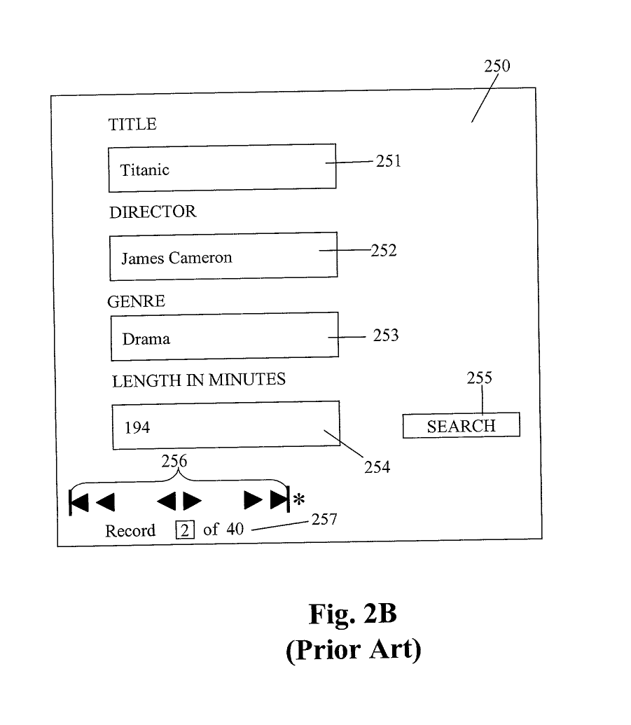

In the drawings and the following detailed description, elements with the same reference numeral are the same element. Also, the first digit of a reference numeral for an element indicates the first drawing in which that element appeared.

### DETAILED DESCRIPTION

A method 330 of this invention provides a graphic user interface that includes a compound view 390 of information in a database that in turn includes a database management system 335 and a plurality of tables 340 including tables 341 to 343. As explained more completely below, compound view 390 facilitates editing data in the database, viewing responses to queries, and viewing data in both a table view and a form view simultaneously.

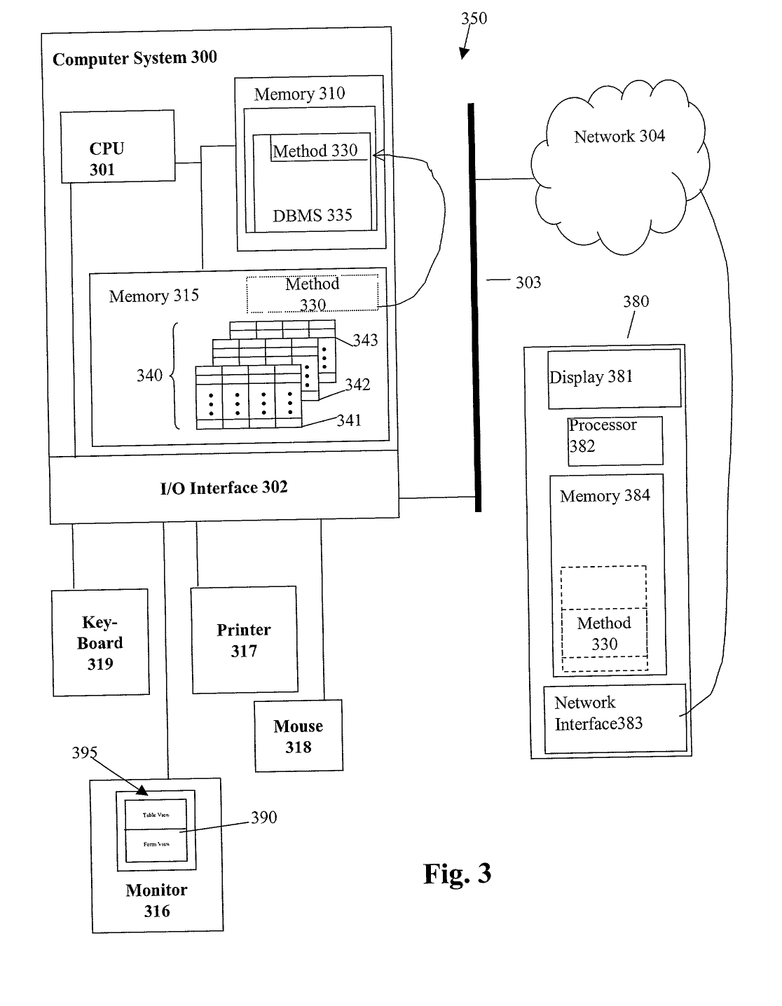

In the embodiment of FIG. 3, compound view 390 is presented on a display screen 395 of a monitor 316. Database management system and method 330 are stored in a volatile memory 310 for execution on CPU 301, while plurality of tables 340 is stored in a non-volatile memory 315 of computer system 300.

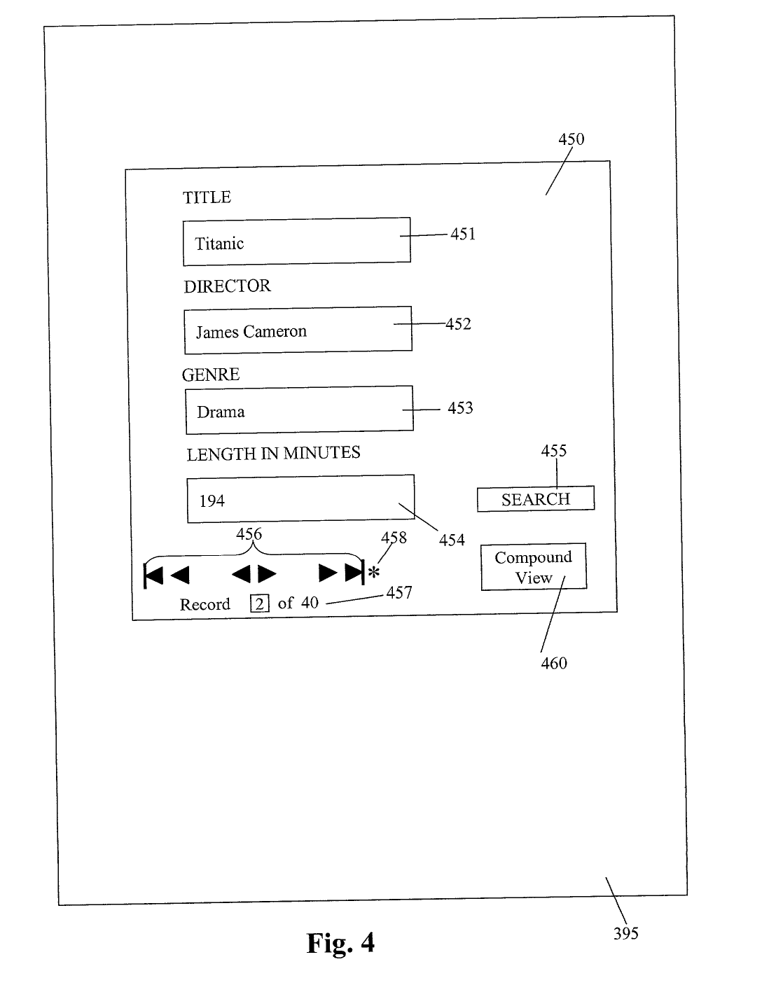

In one embodiment, to access the graphic user interface of this invention, the user utilizes an I/O device, e.g., mouse 318, keyboard 319, or perhaps speech recognition hardware and/or software to open a form 450 (FIG. 4) on display screen 395. In this example, form 450 includes a plurality of multi-function windows 451 to 454. Each multi-function window has a title that corresponds to a column in a table in one of tables 341 to 343, in this example. As is known to those of skill in the art, multi-function windows 451 to 454 can be used to enter data for a new record, sometimes called a dataset, used to edit a record, or used in a query.

Specifically, as illustrated in FIG. 4, window 451 refers to the title of a film and is labeled “Title”. Another window 452 refers to the director of the film and is labeled “Director”. Still another window 453 refers to the genre of the film and finally yet another window 454 refers to the length in minutes of the film. In this embodiment, form 450 includes navigation arrows 456, a record identification field 457, a search initiation button 455, a new record button 458, and a compound view button 460.

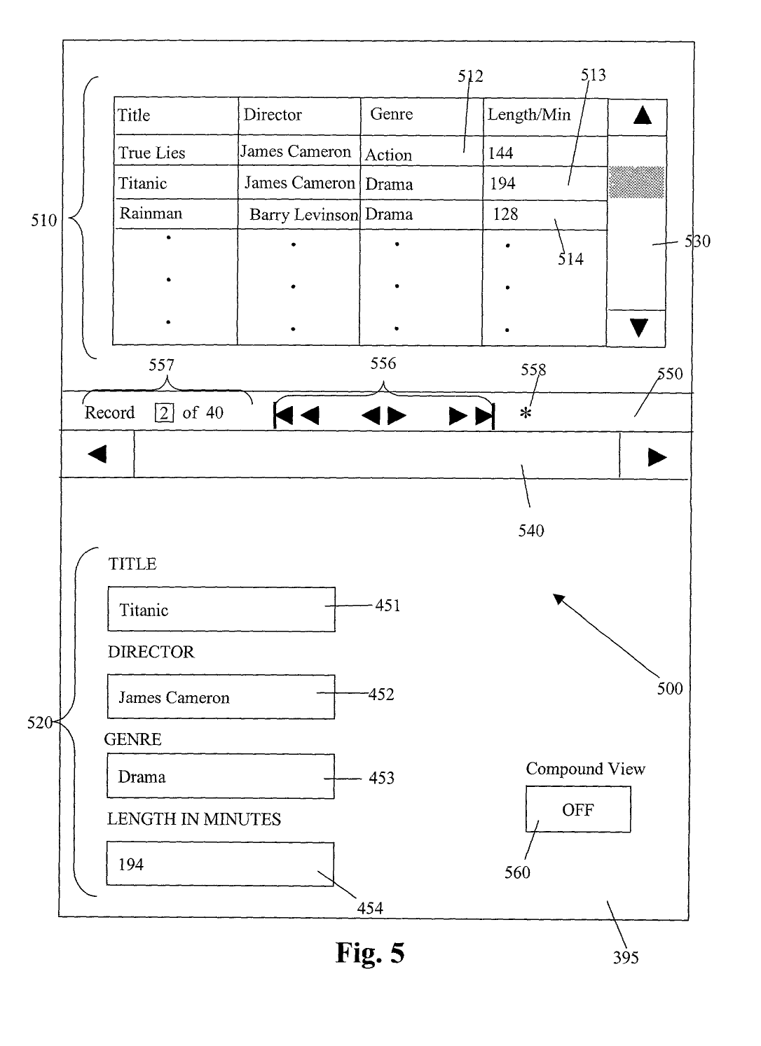

Compound view button 460 enables the user to select a compound view that simultaneously provides the user with a form view and a table view onto the data of the database. In this example, when the user activates compound view button 460, e.g., by clicking on button 460, compound view window 500 (FIG. 5) is presented on display screen 395. Compound view button 460 is illustrative only and is not intended to limit the invention to the use of a specific mechanism. Compound view button could be an icon in a menu bar, an item in a menu, or any other mechanism used in a windowing environment to indicate selection of the compound view window of this invention.

Compound view window 500 includes a table view window 510 and a form view window 520 of a dataset from the same data source. In this example, dataset 513 in table view window 510 also is displayed in form view window 520. However, there are additional datasets, including datasets 512 and 514, displayed in table view window 510.

In this embodiment, datasets 512 to 514, as presented in table view window 510, include a column for each of the data fields presented in form view window 520. In another embodiment, table view window 510 includes a column for each of the data fields presented in form view window 520, but the size of table view window 510 prevents the simultaneous display of all the columns. In this embodiment, at least one of the columns is displayed in table view window 510.

In still another embodiment, each dataset presented in table view window 510 includes a column for all the data fields in that dataset instead of only the data fields presented in form view window 520. Again, in this embodiment, all of the columns may not be displayed simultaneously in table view window 510.

Vertical scroll bar 530 is used for navigating the datasets displayed in table view window 510. Scroll bar 530 typically is used when the number of datasets available for display in table view window 510 exceeds the number that can be displayed at one time in table view window 510.

Horizontal scroll bar 540 is used for navigating within a dataset displayed in table view window 510. Scroll bar 540 typically is used when the number of data fields, e.g., columns, in a dataset exceeds the number that can be displayed at one time in table view window 510.

Toolbar 550 provides the user with several additional options for navigating through the datasets displayed in compound window 500. The options include arrow buttons 556, and a button 558 to insert a new (empty) dataset, which then may be edited and completed in either table view window 510 or form view window 520. Traveling through the data/datasets is possible in both windows 510 and 520 by using arrow buttons 556. Toolbar 550 also supplies a field 557 displaying the (total) number of datasets available to table view window 510 as well as the number of the dataset actually displayed in form view window 520. Compound view window 500 also includes a compound view button 560. If the user selects compound view button 560, e.g., clicks on button 560, the user is returned to form 450 (FIG. 4).

The data of the dataset simultaneously displayed in form view window 520 and table view window 510 are synchronous and show no difference with respect to the two windows. For each window in form view window 520, there is a corresponding column in table view window 510.

Form view window 520 and table view window 510 both relate to the same data source. In another embodiment, the windows within form view window 520 access more than one data table, i.e., form view window 520 contains more than one “logical form.” In this case, table view window 510 only displays one of the corresponding data tables. The user displays datasets from a different data table in table view 510 by selecting a window in form view window 520 associated with the different data table, i.e., by selecting another logical form in form view window 520.

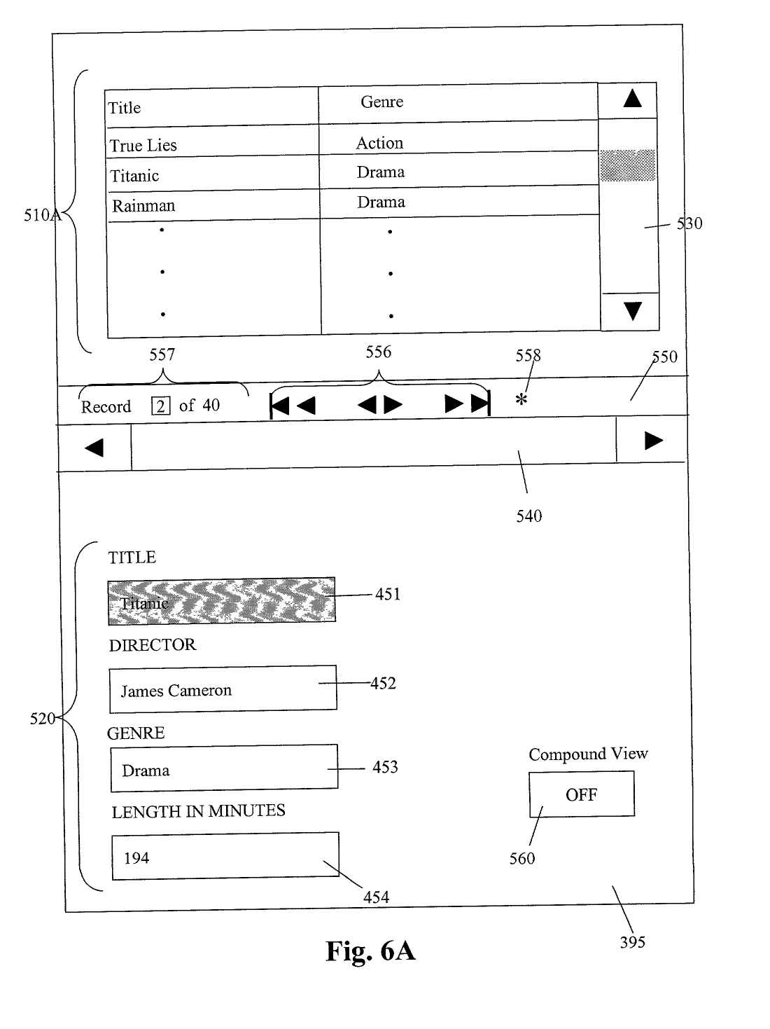

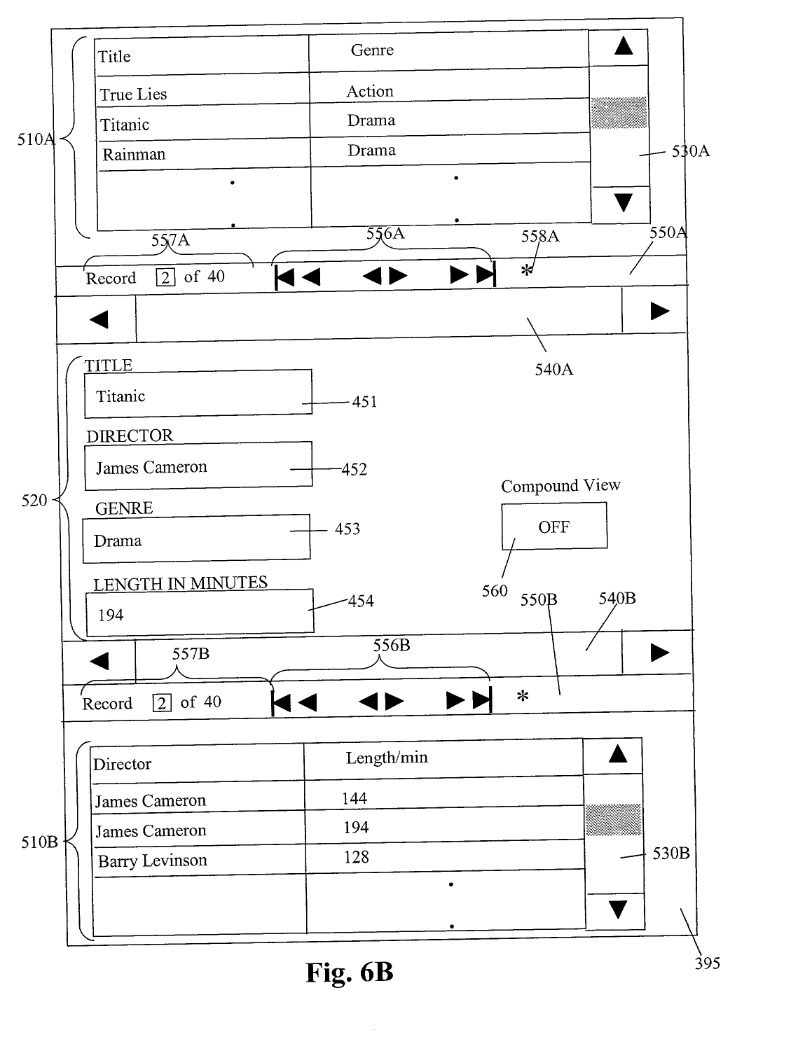

For example, assume that the data in the datasets in table view window 510 is not from a single table, but rather is split into two different tables. A first table includes the title and genre while a second table includes the director and length of a film. Hence, for this table configuration, windows 451 and 453 (FIG. 6A), in form view window 520, form a first logical form, while windows 452 and 454 form a second logical form.

In the example of FIG. 6A, the user has selected window 451, the title column in the first table, and so the datasets displayed in table view window 510A are from the table containing the title and genre. If the user selected a window in the second logical form, the datasets presented in table view window 510A would switch to the second table. All other aspects of the compound view window of this invention are the same as described with respect to FIG. 5.

In another embodiment, as illustrated in FIG. 6B, form view window 520 uses two different data sources, such as two different data tables, and two table view windows 510A and 510B corresponding to the two different data sources are displayed on display screen 395. In this case, one table view window 510A is displayed above form view window 520 and the other table view window 510B is displayed below form view window 520.

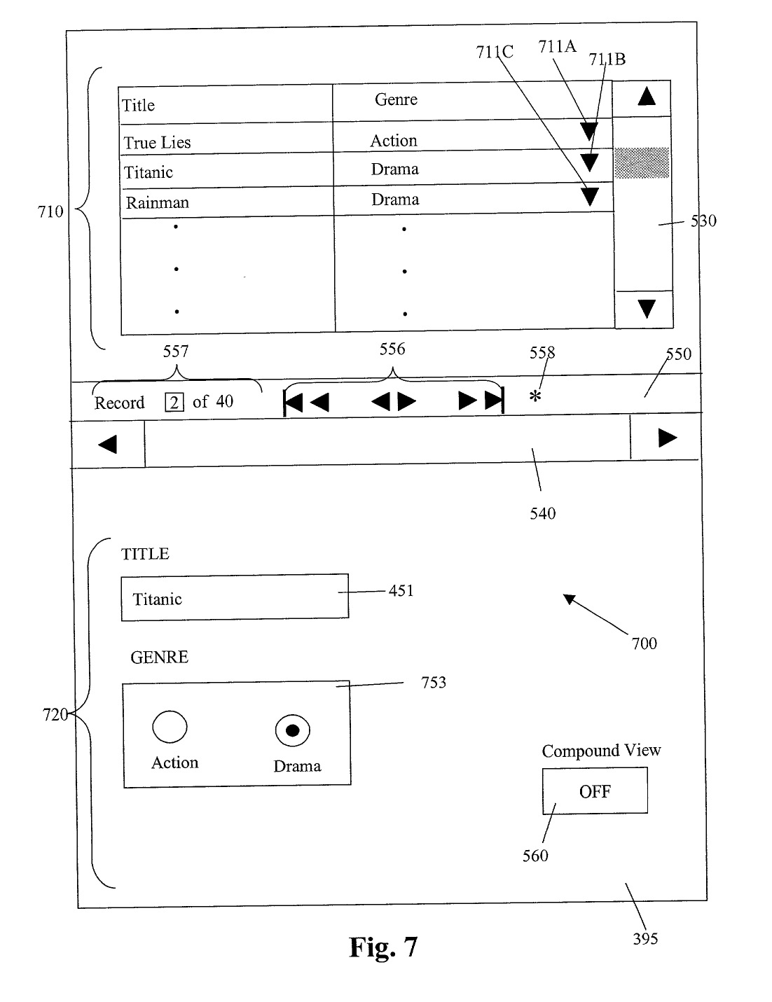

In yet another embodiment of the graphical user interface of this invention, upon selection of compound view button 460 (FIG. 4), the user is presented with compound view window 700 (FIG. 7) that includes table view window 710 and form view window 720. In this example, form view window 720 contains two multi-function windows 451 and 753. The navigation features in this embodiment are the same as those described above, and so that description is incorporated herein by reference.

In this embodiment, column Genre in table view window 710 includes an arrow button in each dataset displayed, e.g., arrow buttons 711A to 711C. By selecting a particular arrow button in a dataset, the user is presented with a list box that includes a list of the options available for selection by the user. If the user selects a particular option, that option is displayed in both windows 710 and 720.

In form view window 720, Genre window 753 is not a fill-in window as in FIGS. 5, 6A and 6B, but rather includes a plurality of radio buttons, one for each option available to the user for the data field. In this example, there are two options available for data field Genre, action and drama, and so there are two radio buttons in Genre window 753. The user can select one of the two options by clicking on the appropriate radio button. The selection is also displayed in window 710.

Thus, for data that has a limited range of options or attributes, compound window 700 facilitates data entry, data editing, and eliminates the possibility of errors in the data field that includes the list boxes in the table view window and the radio buttons in the form view window. In the embodiment illustrated, a list box for a data field includes one entry for each radio button for that data field in the form view window. Alternatively, only the radio buttons or only the list boxes could be used.

The particular forms used in the form view windows are only illustrative and are not intended to limit the form view windows to the particular formats illustrated. In view of this disclosure, those of skill in the art can implement the form and table view windows in any desired format. One important aspect is that the user is simultaneously presented with both views by method 330.

Those skilled in the art will readily understand that the operations and actions taken in connection with the description of the method 330 represent actions performed by a CPU of a computer in accordance with computer instructions provided by a computer program. Therefore, method 330 may be implemented by a computer program causing the CPU of the computer to carry out instructions representing the individual operations or actions as described hereinbefore. The computer instructions can also be stored on a computer-readable medium, or they can be embodied in any computer-readable medium such as any communications link, like a transmission link to a LAN, a link to the internet, or the like.

Thus, method 330 can be implemented by a computer program comprising computer program code or application code. This application code or computer program code may be embodied in any form of a computer program product. A computer program product comprises a medium configured to store or transport this computer-readable code, or in which this computer-readable code may be embedded. Some examples of computer program products are CD-ROM discs, ROM cards, floppy discs, magnetic tapes, computer hard drives, servers on a network, and carrier waves. The computer program product may also comprise signals, which do not use carrier waves, such as digital signals transmitted over a network (including the Internet) without the use of a carrier wave.

Method 330 can be executed on a hardware configuration like a personal computer or workstation as illustrated schematically in FIG. 3 by computer system 300 where all the data sources of interest as well as method 330 are stored on that computer system.

Method 330, however, may also be applied to a client-server configuration 350 that also is illustrated in FIG. 3 where the data sources are distributed across a network, e.g., any combination of networks 303 and 304. The initial operations may be carried out using client device 300 while some or all operations of method 330 are carried out on a server computer 380 accessible by client device 300 over data networks 303 and 304, such as the Internet, using a browser application or the like.

As illustrated in FIG. 3, the storage medium including method 330 that generates the graphic user interface of this invention may belong to computer system 300 itself. However, the storage medium also may be removed from computer system 300. For example, method 330 and DBMS 335 may be stored in memory 384 that is physically located in a location different from processor 301. The only requirement is that processor 301 is coupled to the memory containing method 330. This could be accomplished in a client-server system 350, e.g. system 300 is the client and system 380 is the server, or alternatively via a connection to another computer via modems and analog lines, or digital interfaces and a digital carrier line.

For example, memory 384 could be in a World Wide Web portal, while display unit 316 and processor 301 are in a personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 300, in one embodiment, can be a portable computer, a workstation, a two-way pager, a cellular telephone, a digital wireless telephone, a personal digital assistant, a server computer, an Internet appliance, or any other device that includes the components shown and that can execute method 330, or at least can provide the input instructions to method 330 that are executed on another system. Similarly, in another embodiment, computer system 300 can be comprised of multiple different computers, wireless devices, cellular telephones, digital telephones, two-way pagers, or personal digital assistants, server computers, or any desired combination of these devices that are interconnected to perform method 330 as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 330 can be implemented on a wide variety of computer system configurations. In addition, method 330 could be stored as different modules in memories of different devices. For example, method 330 could initially be stored in a server computer 380, and then as necessary, a module of method 330 could be transferred to a client device 300 and executed on client device 300. Consequently, part of method 330 would be executed on the server processor 382, and another part of method 330 would be executed on processor 301 of client device 300. In view of this disclosure, those of skill in the art can implement the invention of a wide-variety of physical hardware configurations using an operating system and computer programming language of interest to the user. For example, FIG. 3 shows input devices 318 and 319, but other input devices, such as speech recognition software and/or hardware could be used to input the selections and data for method 330.

In yet another embodiment, method 330 is stored in memory 384 of system 380. Stored method 330 is transferred, over networks 304 and 303 to memory 315 in system 300. In this embodiment, network interface 383 and I/O interface 302 would include analog modems, digital modems, or a network interface card. If modems are used, network 304 includes a communications network, and method 330 is downloaded via the communications network.

Method 330 of the present invention may be implemented in a computer program including a comprehensive STAROFFICE office application that is available from Sun Microsystems, Inc. of Palo Alto, Calif. (STAROFFICE is a trademark of Sun Microsystems.) Such a computer program may be stored on any common data carrier like, for example, a floppy disk or a compact disc (CD), as well as on any common computer system's storage facilities like hard disks. Therefore, an embodiment of the present invention also relates to a data carrier for storing a computer program for carrying out the inventive method. Another embodiment of the present invention relates to a method for using a computer system for carrying out the presented inventive method.

While the present invention has been explained in connection with certain embodiments thereof, other embodiments will be apparent to those skilled in the art from consideration of the specification and practice of the invention disclosed therein. It is intended that the specification and examples be considered as exemplary only, without limiting the spirit and scope of the invention.

We claim:

1. A method of enabling a user to access data of a database, said method comprising:
displaying a form view onto a dataset of said database; and
displaying simultaneously a table view onto said dataset accessed by said form view.

2. The method of claim 1 further comprising:
displaying several datasets simultaneously in said table view.

3. The method of claim 1 further comprising:
displaying in said table view datasets from a data source selected by the user in said form view, if more than one data source is accessed by said form view.

4. The method of claim 1 further comprising:
including one column in said table view for each data field contained in said form view wherein at least one column is displayed in said table view.

5. The method of claim 1 further comprising:
displaying a plurality of radio buttons in a window of said form view wherein each radio button represents a different option for one data field of a dataset so that said radio buttons represent a plurality of options.

6. The method of claim 5 further comprising:
displaying a list box for said one data field in said table view wherein said list box lists said plurality of options.

8. The method of claim 1 further comprising:
displaying a scroll bar wherein a user uses said scroll bar for traveling through data in both the table view and the form view.

9. A method of enabling a user to access data of a database, said method comprising:
receiving a selection of a compound view button in a first window; and
generating a second window including a compound view of data in said database.

10. The method of claim 9 wherein said method further comprises:
displaying a form view onto data of a dataset in said database in said compound view; and
displaying simultaneously a table view onto said dataset accessed by said form view.

11. The method of claim 10 further comprising:
displaying several datasets simultaneously in said table view.

12. The method of claim 10 further comprising:
displaying in said table view datasets from a data source selected by the user in said form view, if more than one data source is accessed by said form view.

13. The method of claim 10 further comprising:
including one column in said table view for each data field contained in said form view wherein at least one column is displayed in said table view.

14. A computer program product comprising computer program code for a method for enabling a user to access data of a database, said method comprising:
displaying a form view onto a dataset of said database; and
displaying simultaneously a table view onto said dataset accessed by said form view.

15. The computer program product of claim 14, said method further comprising:
displaying several datasets simultaneously in said table view.

16. The computer program product of claim 14, said method further comprising:
displaying in said table view datasets from a data source selected by the user in said form view, if more than one data source is accessed by said form view.

17. The computer program product of claim 14, said method further comprising:
including one column in said table view for each data field contained in said form view wherein at least one column is displayed in said table view.

18. The computer program product of claim 14, said method further comprising:
displaying a plurality of radio buttons in a window of said form view wherein each radio button represents a different option for one data field of a dataset so that said radio buttons represent a plurality of options.

19. The computer program product of claim 18, said method further comprising:
displaying a list box for said one data field in said table view wherein said list box lists said plurality of options.

20. The computer program product of claim 14, said method further comprising:
displaying a scroll bar wherein a user uses said scroll bar for traveling through data in both the table view and the form view.

20. A system comprising:
a display unit;
a processor coupled to said display unit; and
a memory coupled to said processor, and storing computer instructions for a method of enabling a user to access data of a database wherein upon execution of said computer instructions on said processor, said method comprising:
displaying a form view onto a dataset of said database on said display unit; and
displaying simultaneously a table view onto said dataset accessed by said form view on said display unit.

21. The system of claim 20 wherein said method further comprises:
displaying several datasets simultaneously in said table view.

22. A graphic user interface comprising:
a form window including a compound view button; and
a compound view window displayed upon selection of said compound view button in said form window, wherein said compound view window simultaneously includes:
a form view onto a dataset of a database; and
a table view onto said dataset accessed by said form view.
